(19) United States
(12) Patent Application Publication
(10) Pub. No.: US 2018/0242770 A1
(43) Pub. Date: Aug. 30, 2018

(54) Inverted Juicer Cartridge With Deployable Outlet

(71) Applicant: Fresh Press LLC, San Francisco, CA (US)

(72) Inventors: Yaron Sheba, Mountain View, CA (US); Paul Katz, Pasadena, CA (US); David Kyyoung Lee, San Francisco, CA (US)

(21) Appl. No.: 15/901,785

(22) Filed: Feb. 21, 2018

Related U.S. Application Data
(60) Provisional application No. 62/461,732, filed on Feb. 21, 2017.

(51) Int. Cl. A47J 19/06; B30B 9/04; A23L 2/04

(52) U.S. Cl. CPC A47J 19/06; A23V 2002/00; A23L 2/04; B30B 9/04

(57) ABSTRACT

An apparatus for extracting juice from food matter. The apparatus includes a liquid impermeable compartment having an outer perimeter and a food matter region contained within the outer perimeter. A deployable outlet may be formed in the liquid impermeable compartment outside of the food matter region. A corresponding system and method are also disclosed and claimed herein.

### CROSS REFERENCE TO RELATED PATENT APPLICATION(S)

The present disclosure claims the priority benefit of U.S. Provisional Patent Application No. 62/461,732, filed on Feb. 21, 2017 and entitled “Inverted Juicer Cartridge With Deployable Outlet”, which is herein incorporated by reference in its entirety.

### BACKGROUND

### Field of the Invention

This invention relates to juicers and juicer cartridges.

### Background of the Invention

Devices for extracting fresh juice from food matter, such as fruits and vegetables, have been developed over the years for both home and commercial markets. Typical commercial juicers tend to be large, expensive, and are unsuitable for home or small retail environments. Systems more suitable for home and small retail environments have utilized several different methods for extracting juice from the food matter as described below. Such systems typically require food matter to be prepared for juicing, for example, by cutting the food matter into appropriately sized pieces. Additionally, juicers typically require different components or configurations to extract juice from different types of food matter, and are thus not well suited for preparing custom juice blends.

In centrifugal-type juicers, food matter is fed through a chute or other entrance, and a set of mechanical blades rotating at a high speed cut and/or grind the food matter to a pulp. Centripetal force is then applied by rapidly rotating the food matter to separate juice from the pulp through a filter. A second type of home and retail juicer is a masticating juicer which uses an auger to crush the food matter into a pulp. The resulting pulp is further compressed by the auger to extract juice through an associated filter. Another type of juicer is a hydraulic press juicer, which typically uses a hydraulic press to compress food matter between one or more surfaces that are in direct contact with the food matter to extract the juice.

### BRIEF DESCRIPTION OF DRAWINGS

In order that the advantages of the invention will be readily understood, a more particular description of the invention briefly described above will be rendered by reference to specific embodiments illustrated in the appended drawings. Understanding that these drawings depict only typical embodiments of the invention and are not therefore to be considered limiting of its scope, the invention will be described and explained with additional specificity and detail through use of the accompanying drawings, in which:

FIG. 1A is a plan view of a juicer cartridge in accordance with certain embodiments of the invention;

FIG. 1B is an enlarged plan view of a portion of the juicer cartridge of FIG. 1A, showing an internal edge of the liquid permeable compartment that is spaced from an upstream portion, and relief features of an outlet of the juicer cartridge;

FIG. 2 is a perspective view of the cartridge of FIG. 1A;

FIG. 3 is a schematic view of one embodiment of a juicer cartridge including a single “J” shaped outlet at a top edge of the cartridge to dispense juice into another container;

FIG. 4 is a schematic cross-sectional side view of one embodiment of a juicer cartridge including an internal divider;

FIG. 5 is a schematic cross-sectional perspective view of an embodiment of a juicer cartridge including an internal divider; and

FIG. 6 is a schematic side view of a juicer including a pressing chamber, pressing surfaces, and juicing dispensing area.

### DETAILED DESCRIPTION

Some single-serving cartridge-based juicers are designed to accept juice cartridges or pouches oriented with their outlets below the juice-containing food matter. This “as-used” orientation relative to ground enables gravity-assisted draining of the juice from the cartridge. Unfortunately, however, this design also tends to cause the food matter to spread in all directions in the pouch as the matter is compressed. The variable distribution of food matter can result in trapped pockets of juice and/or air in different regions of the juicer cartridge. As continued compression increases pressure within the cartridge, these pockets of trapped air and/or juice may limit the amount of juice extracted from the pouch.

According to one aspect of the present invention, a juicer cartridge may be provided which includes one or more liquid impermeable compartments containing juice-containing food matter such as fruits or vegetables, or other types of edible products. For example, a juicer cartridge may comprise a pouch formed from two or more liquid impermeable layers bonded or welded around the perimeter to form one or more internal compartments. The internal components may at least partially surround the food matter, and in some embodiments, completely surround the food matter.

The juicer cartridge may further include an extendable or otherwise deployable outlet. The outlet may extend from the rest of the cartridge body (as described in detail below), to provide fluid communication between the one or more liquid impermeable compartments and an exterior of the juicer cartridge to allow juice extracted from the food matter to be dispensed from the cartridge. The juicer cartridge may be positioned within a pressing chamber of a corresponding juicer, such as the juicer embodiments described below, which may then compress the juicer cartridge and the food matter contained therein, in order to extract juice from the food matter, in a manner that may also help to reduce the presence of trapped air and/or juice in the juicer cartridge during a juicing operation.

In one embodiment, a juicer cartridge may be formed with the outlet disposed within the boundaries, or outer perimeter, of the juicer cartridge. In this respect, the juicer cartridge may include an outer perimeter defining within the perimeter a food matter-containing region. Also within the perimeter, but outside of the food matter-containing region, a spout or outlet may be formed that can be deployed to a position to allow juice to flow from the juicer cartridge. For example, the outlet may be deployed from a rest or storage position that is in the plane of the juicer cartridge to a deployed position that is out of the plane of the juicer cartridge.

In some embodiments, the juicer cartridge may be formed as a pouch. The outlet may be defined by a seal (such as a heat seal) joining opposite surfaces of the pouch together. A cut line, or other type of weakened area, may be formed within the sealed region such that the weakened area extends along at least a portion of the length of the seal forming the spout or outlet. The cut line, or other type of weakened area, may allow the outlet to be deployed out of a plane of the pouch as described further below.

In one embodiment, the cut lines may not extend completely through the seal. Instead, the cut lines may be score lines, such that the outlet remains in the plane of the pouch until ready for use. In this respect, the cut lines may effectively form a weakened or scored region allowing the outlet to break apart in a defined location (along the score lines) to allow the outlet to be deployed out of the plane of the juicer cartridge. By not cutting completely through the material (so that the outlet remains intact with the remainder of the pouch until it is ready to be used), the outlet can maintain a relatively sanitary spout area. The outlet may be allowed to break away from the pouch by the action of the user tearing the outlet along the score line, or by an associated juice press applying a deployment force to the outlet to push the outlet out of plane relative to the juicer cartridge so that it breaks away from the juicer cartridge and is placed into a deployed position. In other embodiments, cut lines may be formed completely through the associated seal to form the outlet, and the outlet may simply be retained in the rest or storage position by the elastic nature of the materials forming the pouch, or by some other mechanism known to those in the art.

Depending on its positioning, as the outlet of a juicer cartridge is pushed out of the plane of the juicer cartridge into the deployed position, the edge of an associated mesh, or other type of liquid permeable layer, may create a natural inflection region. In this manner, a bend or kink may form in the outlet that may obstruct the flow of juice through the outlet. Therefore, in some embodiments, an end or edge of a liquid permeable compartment contained within a juicer cartridge, such as a mesh located within the outlet and/or within the cartridge itself, may be spaced away from the cut or score lines defining the outlet, as well as any associated stress relief features associated with the outlet intended to aid with the deployment of the outlet.

In one embodiment, for example, an edge or side of the liquid permeable compartment closest to an upstream portion of the spout or outlet in the deployed state may be spaced from the upstream portion of the deployable outlet. The upstream portion of the deployable outlet may correspond to a location where the outlet is connected to the portion of the liquid impermeable compartment that is not displaced during the outlet deployment. In this manner, as the outlet is pushed out of the plane of the juicer cartridge, the edge of the mesh, or other type of liquid permeable layer, may not cause the outlet to bend or kink. In this manner, the juice may be permitted to flow through the outlet unimpeded.

As noted previously, the presence of compressed food matter may obstruct the flow of extracted juice towards an outlet of a juicer cartridge. Accordingly, in some embodiments, a liquid impermeable compartment, such as a pouch, may be formed with a welded or staked region located inboard of an outer edge of the pouch boundary. The welded region may define a channel between the welded region and the outer edge of the pouch, allowing juice to flow relatively uninhibited by the food matter towards an associated outlet of the juicer cartridge.

In one embodiment, as the pouch is being pressed and the food matter is being compressed, juice on one side of the compressed food matter may flow from the food matter toward the outlet. Juice located on the opposing side of the compressed food matter may initially flow away from the outlet. As this juice flow nears the bottom end of the pouch, it may reverse direction and flow through the channel to an exit located within a portion of the pouch closer to the associated outlet. The juice may then flow out through the outlet. In this way, juice need not flow through the food matter, and instead can flow around the food matter and through the associated outlet. The juice flow may thus avoid being blocked from the outlet by the compressed food matter.

While a juicer cartridge including one or more channels formed in the juicer cartridge using welded and/or staked arrangements is described above, other methods for forming the described channels are also contemplated as the disclosure is not so limited. For example, in one embodiment, one or more temporary channels may be formed within a juicer cartridge. Specifically, one or more portions of the juicer cartridge pouch may be compressed by one or more associated protrusions and an associated surface of the pressing chamber. This compression of the juicer cartridge may form temporary channels within the juicer cartridge outside of a food matter containing area during compression of the juicer cartridge. These temporary channels may function in a similar manner to those described above.

In one embodiment, an outlet of a juicer cartridge may include a plurality of flow paths that provide flows of extracted juice to the outlet from opposing sides of the outlet. That is, juice flowing out from the food matter may flow toward the outlet from opposite directions, and toward each other relative to the outlet. In one embodiment, the outlet may be in fluid communication with a food matter containing region of the juicer cartridge through two or more separate flow paths, where the flow paths extend vertically up from the food matter toward the outlet. The flow paths may then flow past and around the outlet, change direction, and flow towards one another from opposing sides of the outlet. The converging flow paths may then enter into an upstream interior portion of the outlet. The combined flow paths may flow through the outlet to an exterior of the juicer cartridge. When flowing through the outlet in the deployed configuration, the flow paths may extend out of a plane of the other portions of the juicer cartridge and, in some instances, may be in a direction that is out of the plane of the cartridge. In some embodiments, the flow direction may be at least partially reversed.

In some embodiments, additional structures may be incorporated into a juicer cartridge to increase the amount of juice extracted from food matter. For example, in one embodiment, a juicer cartridge may include a divider, such as a layer of material disposed in the food matter region of the juicer cartridge. The divider may effectively divide at least a portion of the food matter into two or more smaller masses of food matter. The divider may be formed using a permeable material, such as a mesh material, or an impermeable material, such as a liquid impermeable film or rigid plate. In either case, this divider may essentially create two pockets within which the food matter is disposed, such that food matter located on a first side of the divider is separated from food matter located on an opposing side of the divider. The pockets may or may not be in fluid communication with one another. Implementing a divider in a juicer cartridge during a pressing operation in this manner may effectively divide the amount of food matter fiber that juice must flow through to reach an associated outlet in half, depending on the location and configuration of the divider layer relative to the amount of food matter being divided. The volume of juice extracted from the food matter may thus be higher with a lower pressing force which may enable, for example, the same extraction volume with a lower force, and/or a higher extraction volume using the same force.

Numerous benefits may also be associated with a juicing system designed to receive an associated cartridge in an orientation where the cartridge's outlet is located above the pressed food matter relative to a surface or base the juicer cartridge and juicer are supported on (e.g., such as a kitchen countertop). This orientation may afford simplicity of operation in addition to other advantages. For example, in such an arrangement, any air contained within a juicer cartridge located in a pressing chamber of a juicer may be expelled from the juicer cartridge through the outlet prior to dispensing juice from the cartridge. Thus, air does not remain trapped in the cartridge, which could potentially block food matter from being completely pressed. Allowing the air to exit first may also allow the juice stream to flow more smoothly out of the outlet, e.g., without sputtering.

In some embodiments, a juicer cartridge may include one or more liquid permeable compartments at least partially disposed within one or more liquid impermeable compartments. In such an embodiment, the liquid permeable compartments may also at least partially surround, and in some instances completely surround food matter contained therein. The liquid permeable compartment may act as a filter when juice is extracted from the food matter. In some embodiments, the liquid permeable compartments may contain different food matter, and the compartments may be sized to appropriately accommodate the type and amount of food matter therein. Therefore it should be understood that the compartments may have any suitable size. As described in more detail below, in some instances the liquid permeable compartments may be formed by bonding or welding a liquid permeable layer together with the liquid impermeable layers. Of course, as detailed further below, various modifications and additional features may be incorporated into a juicer cartridge including the juicer cartridge features disclosed in U.S. Pub. No. 2014/0314918, and Int. App. No. WO2014/182423, each of which are hereby incorporated by reference in their entirety.

As noted above, in some embodiments a liquid impermeable compartment and/or liquid permeable compartment may be formed by bonding or welding together layers of material around their perimeter. As used herein, bonding or welding of liquid impermeable and/or liquid permeable layers generally refers to any suitable bonding method, including, but not limited to, heat welding, ultrasonic welding, adhesive bonding, or any other suitable joining method that may be used to secure layers of material together. In some embodiments, a weld around a liquid permeable compartment may form a fluid-tight seal, and may be strong enough to withstand the forces applied to the weld during pressing of the juicer cartridge in an associated juicer.

Turning now to the Figures, several non-limiting embodiments are described in more detail. However, it should be understood that the juicers and juicer cartridges described herein should not be limited to only the embodiments shown in the Figures. Instead, the various aspects and components of the juicers and juicer cartridges described herein may be used in any appropriate arrangement or combination.

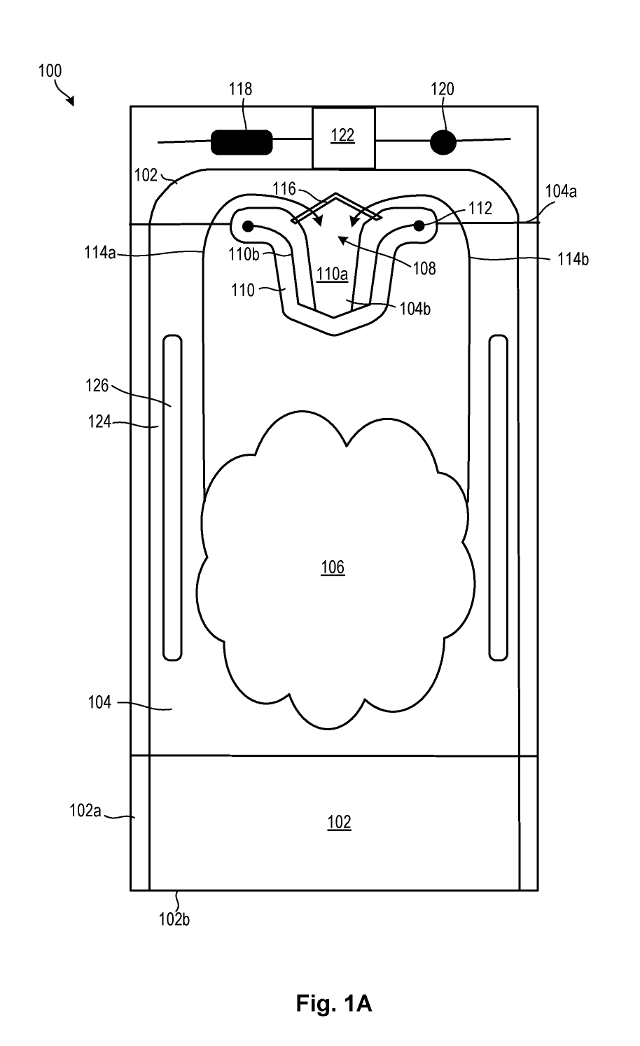

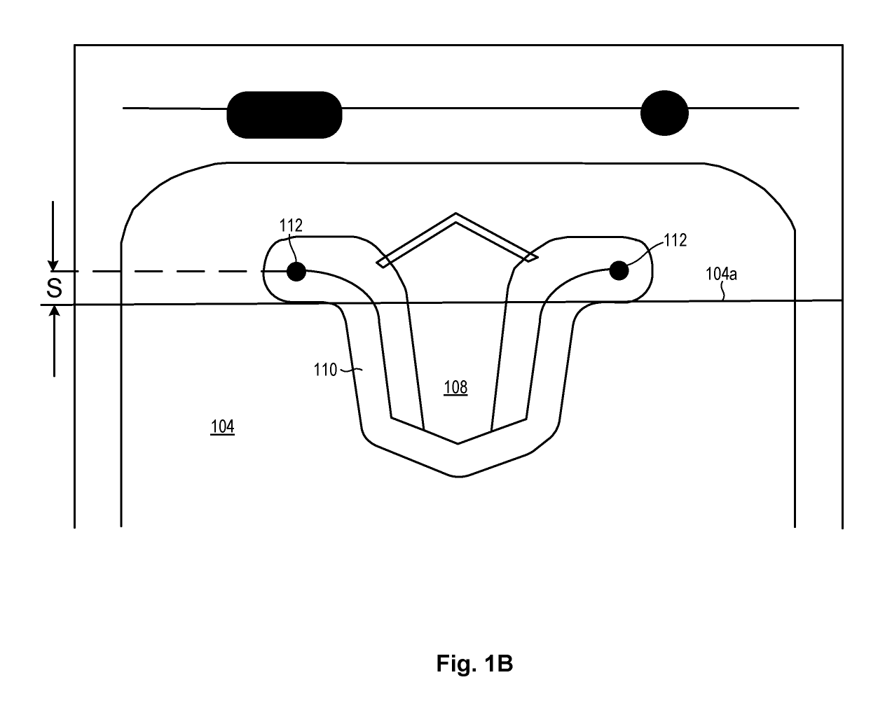

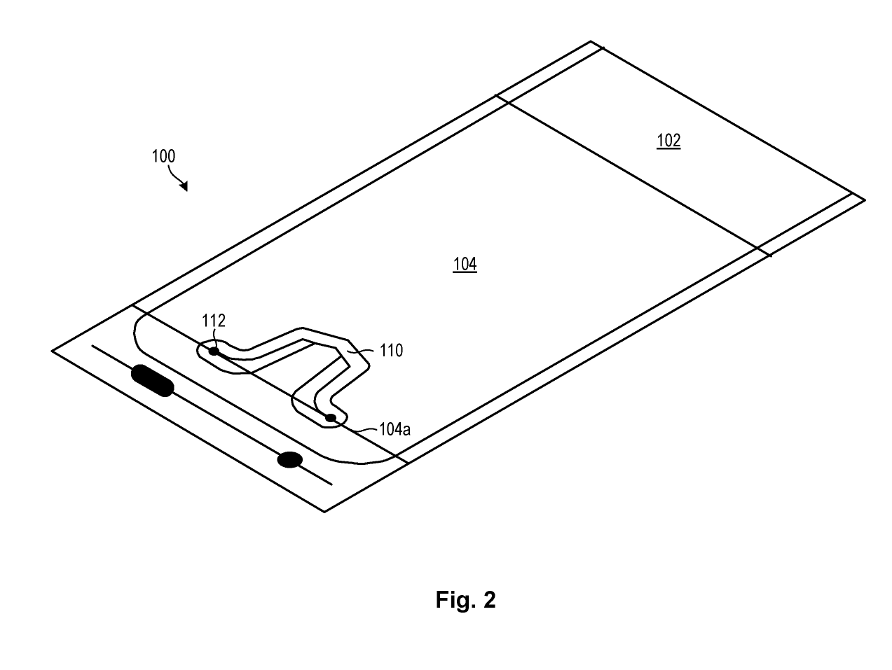

FIGS. 1A, 1B, and 2 depict embodiments of a juicer cartridge 100 or juicer pouch. As discussed above, in some embodiments, a juicer cartridge 100 may include a liquid impermeable compartment 102 that at least partially surrounds, or completely surrounds, a liquid permeable compartment 104 that contains juice-containing food matter 106. As noted above, the liquid permeable compartment 104 may comprise one or more liquid permeable layers that at least partially surround the juice containing food matter 106. In this manner, the liquid permeable layers may act as a filter when juice is extracted from the food matter 106.

Depending on the embodiment, a liquid permeable and/or liquid impermeable compartment may be formed from one or more layers of liquid permeable or liquid impermeable material folded to form two layers. The folded layers may be welded around their periphery to form a seal 102a defining the desired compartments. Of course, embodiments in which a juicer cartridge 100 does not include a liquid permeable compartment are also contemplated. Further, although compartments formed from a single folded sheet or layer of material is described above, in other embodiments the liquid impermeable and/or liquid permeable compartments may be formed from two or more layers of liquid permeable material bonded together along their periphery. In either case, the liquid impermeable and liquid permeable compartments may be constructed from materials and include welds or other seals capable of supporting pressures sufficient to extract juice from the food matter 106 contained therein during a pressing operation without uncontrollably rupturing. Additionally, while a rectangular juicer cartridge 100 has been depicted in the Figures, a juicer cartridge 100 in accordance with the invention may have any appropriate shape.

In some embodiments, a juicer cartridge 100 may include an outlet 108 from the liquid impermeable compartment 102 through which juice extracted from the food matter may flow. In some instances, the outlet may be integrally formed in the one or more layers forming liquid impermeable compartment. Further, in some embodiments, the outlet 108 may be a deployable outlet formed in a region of the liquid permeable compartment that is within the outer perimeter boundary of the liquid impermeable compartment, and outside of a corresponding food matter region of the liquid impermeable compartment. As shown, for example, the outlet may be formed by a seal 110, such as a weld or adhesive, that joins opposing surfaces of the one or more layers forming the liquid impermeable compartment, and in some instances the liquid permeable compartment as well. In this particular embodiment, the seal 110 forming the outlet 108 defines an elongated flow path 110a with the seal 110 forming two opposing sides of the flow path 110a as well as a sealed end of the outlet 108.

When the outlet 108 is in an un-deployed rest or storage configuration, the outlet 108 may be in-plane with the other portions of the juicer cartridge 100. Thus, in the depicted embodiment, a flow path 110a through the outlet is directed towards an interior of the area contained with a perimeter of the juicer cartridge 100, while the outlet 108 is in the rest or storage configuration. However, embodiments in which the flow path 110a of the outlet 108 is directed towards an exterior perimeter of the juicer cartridge 100 in the un-deployed rest or storage configuration are also contemplated.

The seal 110 defining an outlet 108 may have any appropriate shape. As shown in the Figures, proceeding from left to right, the seal 110 includes a first curved portion that curves towards an interior of the juicer cartridge 100 seal. The seal then includes a straight portion extending from the curve toward an interior of the juicer cartridge to form an exterior edge of the outlet. The seal may then extend in a perpendicular direction towards a central axis of the outlet 108 across the juicer cartridge 100, or it may be angled relative to the straight portion of the seal 110, to form an outward or inwardly extending tip at a downstream portion of the outlet 108. The right side of the seal 110 may be a mirror image of the structure described above to form the opposing side of the outlet 108. Thus, the seal 110 may define an outlet 108 with an overall shape similar to a “U” or “V” including curved upper ends. However, other shapes (such as a straight-edged square, rectangular, or other appropriately shaped flaps or tabs) may be formed by the seal 110, as the current disclosure is not limited to any particular shape of outlet 108.

In order to form a deployable outlet 108, the seal 110 may include one or more weakened areas (relative to the other portions of seal 110) that extend along at least a portion of the length of the seal 110. Accordingly, when a deployment force is applied to the outlet 108, the one or more weakened areas of the seal 110 may break apart in a predefined location along the weakened areas, permitting a downstream portion of the outlet 108 to be displaced out of plane relative to the juicer cartridge 100, while the remainder of the juicer cartridge 100 remains intact.

For example, as depicted in the Figures, a cut line 110b, such as a scored cut extending partially through a thickness of the seal 110, may be formed within and extending along a length of the seal 110 to define the outlet 108. Additionally, a portion of the cut line extending across the flow path 110a may extend outside of the seal 110 to permit the deployed outlet 108 to have an open end when moved to the deployed configuration. For example, when a deployment force is applied to the outlet 108 in a direction substantially perpendicular to a face of the juicer cartridge 100, the seal 110 may break part along the cut line, releasing the outlet 108 exterior edges from the juicer cartridge 100 and opening a downstream end of the outlet 108 as the outlet 108 is displaced to the deployed configuration. The noted deployment force may be manually applied by a user, or in some embodiments a protrusion or other feature located within a pressing chamber of an associated juicer may be pressed against the outlet 108 during a loading or pressing operation to move the outlet 108 to a deployed configuration.

In some embodiments, it may be desirable to include stress reliefs at the ends of a cut line 110b defining an outlet 108 to help minimize the chance of additional tearing of the seal 110. Additionally, in some embodiment, the stress reliefs may also aid in deploying the outlet without forming a kink therein. For example, in the depicted embodiment, one or more relief cuts 112 are formed at the opposing ends of the cut line 110b within the seal 110 defining the outlet 108. The depicted relief cuts 112 are circular holes, though other shapes may also be used as desired.

To control when juice is dispensed from an outlet 108 of a juicer cartridge 100, one or more frangible, or burstable, seals 116 may be disposed along a flow path 110a between the liquid permeable compartment 104 containing the food matter 106 and an opening from the outlet 108. As described in more detail below, the frangible, or burstable, seal 116 may open once a pressure above a threshold pressure has been applied to the juicer cartridge to place the liquid permeable compartment 104 and the opening from the outlet 108 in fluid communication with one another. While the seal 116 may have any appropriate shape, in some embodiments, a chevron oriented away from the outlet 108 may be used which may help in reliably opening the frangible, or burstable, seal 116 at a desired location, with a controlled force.

As depicted in FIGS. 1A and 1B, in some embodiments, a liquid permeable compartment 104 may be spaced from an internal edge of a juicer cartridge 100 adjacent to a juicer cartridge outlet 108. In this respect, an edge 104a of the liquid permeable compartment closest to the outlet 108 may be spaced away from an upper edge of the cartridge 100. Edge 104a may be formed by folding a single sheet of liquid permeable material which may help add strength to this region of the liquid permeable compartment 104. However, if the edge 104a is co-located with an upstream portion of the outlet 108 that is bent to deploy the outlet, as shown in FIG. 1A, this may result in a kink forming in the outlet 108. To mitigate the formation of kinks in the outlet 108, the edge 104a may be spaced away from the upstream portion of the deployable outlet 108.

For example, FIG. 1B depicts an embodiment where the edge 104a of the liquid permeable compartment 104 is spaced a distance “S” from the ends of cutline 110 and/or relief cuts 112. This spacing of the edge or side may be on either side of the ends of cutline 110 and relief cuts 112, though in some embodiments, the edge 104a or side of the liquid impermeable compartment may be located below the ends of the cutline 110 and relief cuts 112 such that the most upstream portion of the outlet 108 is located in a region of the liquid impermeable compartment that is outside of the liquid permeable compartment 104. However, embodiments in which the cutline ends 110 and relief cuts 112 are formed in the layers forming both the liquid permeable and liquid impermeable compartments 104, with the edge or side of the liquid permeable compartment located between an interior edge or side of the liquid permeable compartment and the cutline ends 110 and/or relief cuts 112, are also contemplated.

While a single liquid permeable compartment has been depicted in the Figures and described in the embodiment above, it should be understood that a juicer cartridge 100 may include more than one liquid permeable compartment 104, and each liquid permeable compartment 104 may be spaced from the internal edge of the liquid impermeable compartment as well.

It should be noted that an outlet 108 of a juicer cartridge 100 may be formed in a portion of the juicer cartridge 100 that only includes the outer liquid impermeable layer. However, as depicted in FIGS. 1A, 1B, and 2, in some embodiments, the liquid permeable material is located within a flow path 110a extending through an outlet 108 of the juicer cartridge 100. Accordingly, the outlet 108 may include a liquid permeable material 104b, such as a mesh, disposed within the flow path through which extracted juice flows as it is expressed from the cartridge. In this particular embodiment, the mesh located in the outlet 104b corresponds to a portion of the layers of material forming the liquid impermeable compartment such that the seal 110 forming the outlet 108 is made in both the liquid permeable and liquid impermeable material layers. In such a configuration, the seal 110 holds the liquid permeable material within the outlet 108. Such an arrangement may also provide additional filtering of the juice and/or may help to reduce, and possibly prevent, the juice from sputtering as it exits the outlet 108. Without wishing to be bound by theory, the mesh in the outlet 108 may tend to break up the flowing juice, similar to a faucet aerator causing flowing water from a faucet to flow more evenly without sputtering or splashing.

As noted above, a juicer cartridge 100 may be configured to provide consistent and/or predictable flow from an outlet 108 and to reduce the chance of isolated pockets of fluid from forming in the juicer cartridge 100. This may in turn help to ensure that the extracted juice is directed into a beverage container without the cartridge leaking or otherwise failing. In one such embodiment, a juicer cartridge 100 may be configured such that there are two or more fluid paths contained within the one or more liquid impermeable compartments. These fluid paths may fluidly couple the liquid impermeable compartment with the outlet 108.

For example, as shown in FIGS. 1A, 1B, and 2, two flow paths 114a and 114b are located to either side of the outlet 108 above the liquid permeable compartment and juice containing food matter. Accordingly, when the juicer cartridge 100 is pressed, extracted juice flows up into the two separate flow paths passing along each side of the outlet 108. The juice then reverses direction to exit downwards through the extended outlet 108. Such a configuration may permit air present in the juicer cartridge 100 to be expelled from the juicer cartridge 100 before the extracted juice is dispensed. This configuration may mitigate the presence of excess air volume enlarging the cartridge 100 volume during pressing, as well as sputtering associated with pockets of air being discharged with the extracted juice. In the depicted embodiment, the fluid paths 114a, 114b are formed in a region of the liquid impermeable compartment that does not include the liquid permeable compartment. However, embodiments in which the flow paths 114a, 114b extend through one or more portions of the liquid permeable compartment are also contemplated.

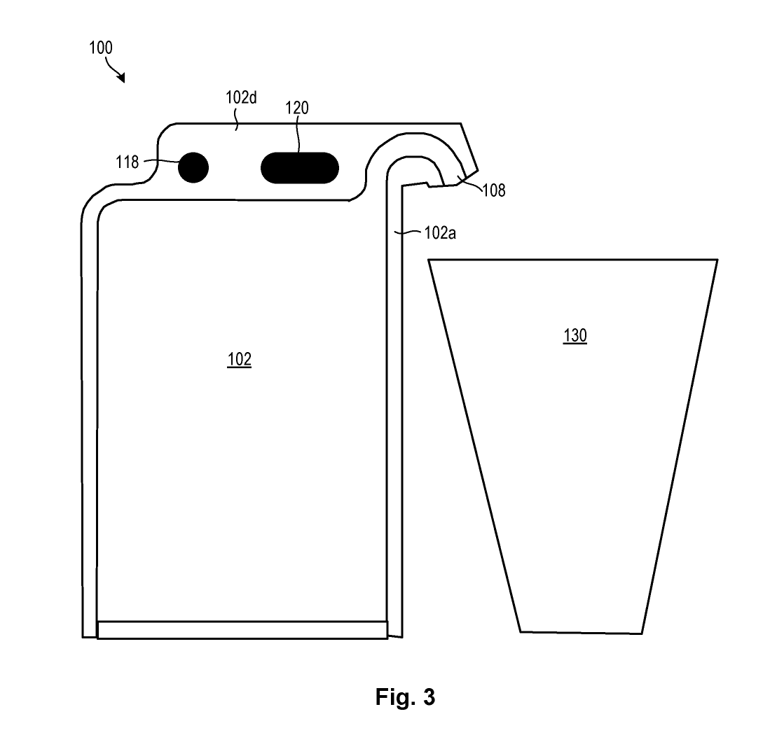

FIG. 3 depicts another embodiment of a juicer cartridge 100 for use in a vertical orientation to dispense extracted juice into a container 130 located vertically below an outlet 108 therein. As illustrated, a liquid impermeable compartment 102 may include a seal 102a that extends at least partially, and in some embodiments, entirely, around an outer perimeter of the liquid impermeable compartment 102. A pre-formed outlet 108 that exists prior to pressing, puncturing, or otherwise operating or pressing the juicer cartridge 100, may be formed such that it extends through a portion of the seal 102a to an outer edge, or exterior, of the liquid impermeable compartment 102 and/or juicer cartridge 100.

As depicted in FIG. 3, the outlet 108 extends outwards from an interior of the liquid impermeable compartment 102 in a substantially vertical upwards direction from a first side of the cartridge 100, prior to curving to a different substantially vertically downward direction. This may also be viewed as extending in a first direction, and in a second substantially opposing direction. In some embodiments, the portion of the seal 102a including the downwardly directed portion of the outlet 108 may extend beyond a side and exterior edge of the cartridge 100 that is adjacent to the first side of the of the juicer cartridge 100 in a direction substantially parallel to a base of the cartridge 100. Additionally, the outlet 108 formed in the above manner may have a shape that is somewhat similar to an upside down “J” or sidewise “C”.

To help increase a stiffness and support for the portion of a juicer cartridge 100 including the outlet 108, the portion of the seal 102a in which the outlet 108 is formed may be an enlarged sealed area 102d relative to other adjacent portions of the seal 102a located to one or both sides of the enlarged sealed area. This enlarged area 102d may have a width dimension that is sufficient to accommodate the shape of the outlet 108 within the seal, with an furthest downstream portion of the outlet 108 extending to an exterior edge of some portion of the seal. For example, the figure depicts an enlarged rectangular area of the seal in which the “J” or “C” shaped outlet 108 is formed with the downstream open end of the outlet 108 extending laterally outwards from a corresponding side of the juicer cartridge 100.

During use, the juicer cartridge 100 may be compressed to extract juice from food matter contained therein. The extracted juice may then flow in a first direction, e.g. vertically upwards relative to a base of an associated juicer, where it would enter the outlet 108 and continue in this first vertical direction. The juice would then follow the depicted curved portion of the outlet 108 redirecting the stream of juice towards an opposing, or vertically downwards oriented direction, at a point that is located laterally outwards from an adjacent side edge of the juicer cartridge 100. Due to the downstream opening of the outlet 108 being laterally spaced from an adjoining side of the juicer cartridge 100, a beverage container 130 may be located beneath the outlet 108 opening such that the extracted juice may be dispensed from the outlet 108 into the beverage container.

For the sake of clarity, the illustrated embodiment of a juicer cartridge 100 is shown using only the outer liquid impermeable compartment and corresponding seal 102a, with an outlet 108 formed there through. However, the depicted embodiment may include an inner liquid impermeable compartment 104, food matter, one or more frangible/burstable seals located along a flow path through outlet 108, and/or any other appropriate features described in relation to the other juicer cartridge 100 embodiments disclosed herein. These features may be combined with the disclosed juicer cartridge 100 in any appropriate manner.

Referring again to FIG. 1A, to further mitigate the creation of isolated pockets of air and/or extracted juice within a juicer cartridge 100, in some embodiments, a juicer cartridge 100 may include one or more channels 124 extending along a length of the juicer cartridge 100 from a first bottom region of a liquid impermeable compartment 102 towards an opposing upper region of the liquid impermeable compartment 102. These one or more channels 124 may place the first side of the liquid permeable and liquid impermeable compartments 104, 102 located on one side of the food matter 106 in fluid communication with an outlet 108 formed in the liquid impermeable compartment 104 on an opposing side of the food matter 106. In the depicted embodiment, one or more welded or staked regions 126 may be formed in the liquid impermeable compartment 102 inboard of an outer edge of the liquid impermeable compartment 102 boundary. The welded regions may thus define the channels between the welded regions and the outer edges of the pouch allowing juice to flow relatively uninhibited by the food matter 106 towards an associated outlet 108 of the juicer cartridge 100.

Having described the general arrangement of one or more liquid permeable and liquid impermeable compartments 104, 102, a manufacturing process for the juicer cartridge 100 depicted in FIGS. 1A, 1B, and 2, is described in further detail.

In one embodiment, one or more layers of liquid permeable material may be folded to form a liquid permeable compartment 104 with a folded edge 104a. This folded liquid permeable material may then be placed between two opposing layers of a liquid impermeable material that forms the corresponding liquid impermeable compartment 102. In the depicted embodiment, the folded edge 104a of the liquid permeable compartment may be spaced from a corresponding interior edge of the liquid impermeable compartment 102. A seal 102a is then formed along at least a portion of the exterior of both the liquid permeable and liquid impermeable compartments 104, 102.

As shown, some portions of the seals in the liquid permeable and liquid impermeable layers may be combined. For example, in this particular embodiment, a portion of the seal 102a extending along the sides of the liquid permeable compartment 104 is combined with the seal of the liquid impermeable compartment 102. In some instances, an open end 102b may be left unsealed to permit filling of the juicer cartridge 100 with food matter 106 after the juicer cartridge 100 formation process is complete. A seal may then be formed across the open end after the juicer cartridge 100 has been filled with food matter 106.

In addition to sealing the periphery of a juicer cartridge 100, a seal 110 may be formed on an interior portion of the liquid impermeable compartment 102 to form an outlet 108. As depicted, the seal 110 forming the outlet 108 may be formed within the outer perimeter of the liquid impermeable compartment 102, defined by the seal 102a and outside of a food matter 106 containing region of the liquid impermeable compartment 102. The seal 110 defining the outlet 108 may be shaped as detailed previously above. Further, the seal 110 may be formed using any appropriate method including thermal welding, ultrasonic welding, adhesives, and/or the like.

Once the seal 110 defining the outlet 108 is formed, a secondary frangible, or burstable, seal 116 may be formed at an upstream portion of the outlet 108 using any appropriate sealing method. A cut line 110b defining the outlet 108 may also be formed through a portion of the seal thickness and along a length of the seal by pressing a sharpened edge against the seal 110 in the desired shape, running a scoring knife along the seal 110, or using any other appropriate method of forming a weakened area in the seal 110. Relief cuts 112 may then be formed at opposing ends of the cut line using a cutting press or other appropriate operation.

In some embodiments, in order to provide one or more flow paths 114a, 114b around the food matter 106 contained in a juicer cartridge 100, one or more channels 124 may be formed in the juicer cartridge 100 as previously described. Specifically, the opposing layers of a liquid permeable compartment 104 may be welded, staked, or otherwise attached to one another to form a channel 124 between the welded or staked region 126 and a corresponding internal edge or side of the liquid impermeable compartment that the region is spaced from. In the depicted embodiment, the welded or staked regions 126 correspond to an elongated straight weld attaching opposing sides of the liquid impermeable, and in some embodiments, opposing sides of the liquid permeable compartments, to one another. However, it should be understood that any appropriate shape, length, and/or thickness of weld may be used.

As described further below, the above-noted seals 110 may be formed using any appropriate technique including, but not limited to, heat welding, ultrasonic welding, heat based adhesives, and/or any other appropriate attachment technique.

Depending on how the juicer cartridge 100 is to be used, one or more cartridge coupling features 118 and 120, such as the depicted cutouts, may be formed along a seal 102a extending along the juicer cartridge 100 periphery. In some instances the coupling features 118, 120 may be formed on an upper portion of the juicer cartridge 100 to support the juicer cartridge 100 in a desired orientation with the outlet 108 oriented towards a supporting surface when the juicer cartridge 100 is located within a pressing chamber of a juicer. The cutouts 118, 120 may have any appropriate size, shape, and/or layout for engaging corresponding couplings (such as hooks and/or protrusions) within a pressing chamber to define a correct orientation, and support, the juicer cartridge 100 in the pressing chamber. In this particular embodiment, corresponding oval and circular cutouts 118, 120 have been illustrated. However, other shapes, sizes, arrangements, and/or numbers of coupling features may be formed in the juicer cartridge 100 to provide a desired orientation.

Additionally, other types of supports located on other regions of the juicer cartridge 100 may also be used. The above-noted orienting features may be used to properly align a juicer cartridge 100 outlet 108 with a corresponding pressing chamber outlet 108, a deployable juicer cartridge 100 outlet 108 with one or more deployment features of the juicer, or any other appropriate feature of a juicer cartridge 100 with a corresponding feature of the juicer. In some embodiments, an information region 122 may either be printed onto, or otherwise integrated with the juicer cartridge 100 for providing information to a user and/or a juicer in which the juicer cartridge 100 is located. For example, in the embodiment shown in FIGS. 1-3, the juicer cartridge 100 includes an information region 122 located between the cartridge couplings 118 and 120. When the juicer cartridge 100 is correctly loaded in the pressing chamber of a juicer, the information region may face a corresponding reader of the juicer such that the reader may read the information contained within the information region which may be used to control one or more aspects of the juicer's operation. Appropriate types of information regions include, but are not limited to printed or digital indicator technologies such as bar codes, quick response codes, RFID devices, magnetic strips, a color bar or other similar graphics, a time temperature indicator, and any other suitable readable medium.

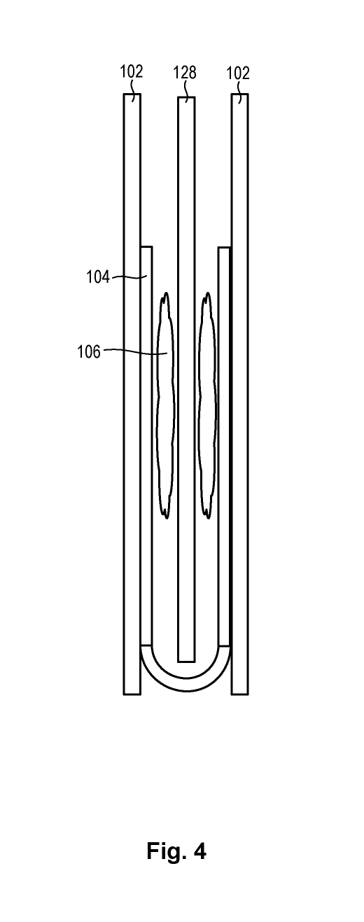

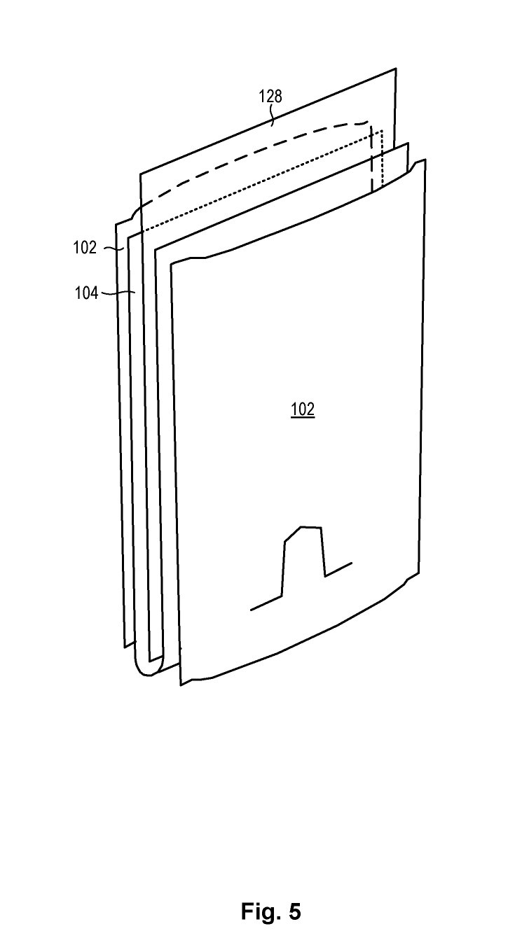

As illustrated in FIGS. 4 and 5, in some embodiments, a juicer cartridge 100 may include one or more dividers 128 located within a liquid permeable compartment 104 containing food matter 106 to divide the food matter into two or more masses. In certain embodiments, the juicer cartridge 100 may include a liquid impermeable compartment 102 that at least partially surrounds the liquid permeable compartment, and the liquid permeable compartment 104 at least partially surrounds the food matter. As illustrated, the divider may extend along at least a portion of the length of the liquid permeable compartment 104 such that it divides the food matter 106 into at least a first portion on a first side of the divider 128 and a second portion located on a second opposing side of the divider 128. It should be noted that the divider 128 may span across an entire width, height, or other appropriate dimension of the liquid permeable compartment 104. However, embodiments in which the divider 128 only spans across a portion of a particular dimension of the liquid permeable compartment 104 are also contemplated. Additionally, the divider 128 may be formed from any appropriate material including, but not limited to, a permeable material, such as a mesh material, or an impermeable material, such as a liquid impermeable film or rigid plate.

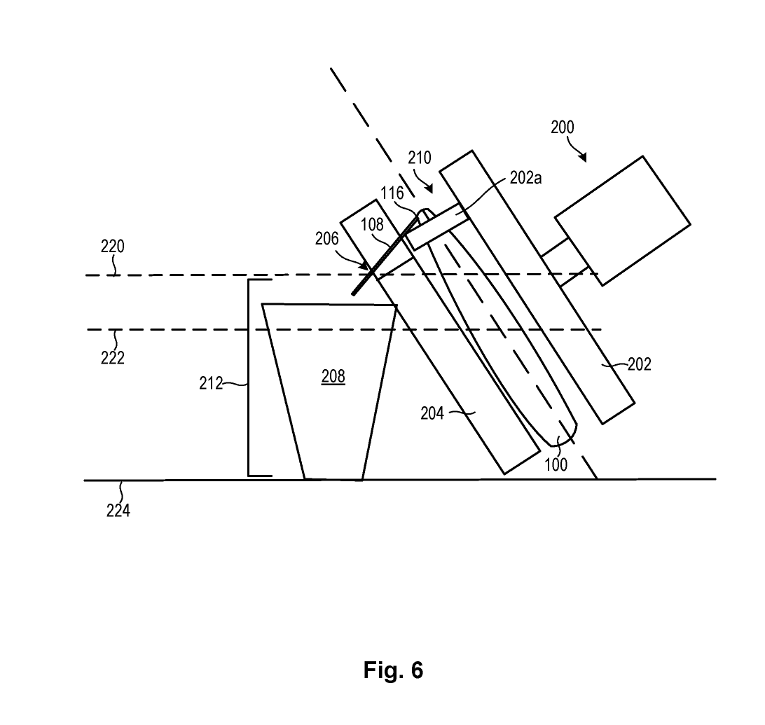

FIG. 6 illustrates the use of a juicer cartridge 100 within a corresponding juicer 200. In the depicted embodiment, one or more juicer cartridges 100 are received in a pressing chamber 210 having a size and shape to receive the juicer cartridges 100 in an angled or substantially vertical orientation. In this manner, the deployable outlet 108 of the juicer cartridge 100 may be positioned in an upper portion of the pressing chamber 210 relative to a base of the juicer and/or a surface of the juicer is resting. The pressing chamber 210 may also include a juicer outlet 206 that is located above the majority of the cartridge 100 when disposed within the pressing chamber 210. The juicer outlet 206 is designed to receive the deployable outlet 108 of the juicer cartridge 100 when it is in the deployed configuration.

Depending on the particular embodiment, the juicer outlet 206 may be constructed and arranged such that the outlet 108 of the juicer cartridge 100 extends beyond an exterior edge of the juicer outlet 206 to an exterior of the juicer. A dispensing area 212 may be located adjacent to the juicer outlet 206 such that the dispensed juice may be directed from the outlet 108 of the juicer cartridge 100 directly into a beverage container 208 when the juicer cartridge 100 is pressed. The dispensing area 212 may correspond to any appropriate feature including a recess formed in a housing of the juicer, an area adjacent the juicer, a cup holder, or any other appropriate configuration. Such an embodiment may help to reduce or eliminate contact between the juicing system and any extracted juice in order to minimize contamination and/or cleanup of the juicer after juicing.

The above noted pressing chamber may also include one or more pressing surfaces 202 and 204. One or more of these surfaces may be a displaceable pressing surface that is driven by a suitable drive mechanism during actuation to apply pressure to the juicer cartridge 100 during a juicing operation in order to apply pressure to the food matter contained therein and extract juice from the food matter. The applied pressure may then cause the extracted liquid to flow upwards away from the food matter and through the juicer cartridge 100 outlet 108 to an exterior of the juicer cartridge 100.

In some embodiments, it may be desirable to have a pressing operation of a juicer automatically deploy a deployable outlet 108 of a juicer cartridge 100. In such an embodiment, a protrusion 202a, extendable component, or any other appropriate feature capable of applying a force to the deployable outlet 108 may be use to move the outlet 108 to the deployed configuration either prior to, or during, a juicing operation. For example, a protrusion 202a formed, or otherwise located, on a displaceable pressing surface may be pressed against the outlet 108 during an initial stage of a pressing operation prior to significant juice extraction to move the deployable outlet 108 to the deployed configuration. The displacement of the one or more displaceable pressing surfaces 202, 204 may then continue until the juicer operation is completed. Alternatively, an extendable surface, such as an extendable rod, shaft, bar, or other extendable feature may be located in any appropriate portion of the juicer may be extended into the pressing chamber and against the deployable outlet 108 of the juicer cartridge 100 to deploy the outlet 108 into the corresponding juicer pressing chamber outlet 206. Of course other ways of deploying the outlet 108 are also contemplated as within the scope of the present invention. In either case, in some embodiments, the timing and operation of the deployable outlet 108 deployment may be arranged such that the outlet 108 is deployed to dispense juice into an associated container 208 prior to a frangible, or burstable, seal 116 associated with the outlet 108 opening to help prevent contact of dispensed juice with the juicer.

Depending on the particular embodiment, a juicer cartridge 100 may be held at an angle relative to a supporting surface a base of the juicer is resting on during operation that is greater than or equal to 45°, 60°, 70°, 80°, 90°, or any other appropriate angle. Correspondingly, the juicer cartridge 100 may be oriented at an angle that is less than or equal to 90°, 80°, 70°, 60° or any other appropriate angle relative to the supporting surface. Combinations of the above noted ranges are contemplated including 45° to 90°, though other combinations of the noted ranges are also possible as the disclosure is not so limited. Additionally, while a juicer that maintains a juicer cartridge 100 in a specific range of angles relative to a base or supporting surface has been described, the use of juicer cartridges 100 in other orientations and different ranges of angles other than those noted above are also contemplated as the disclosure is not limited in this fashion.

FIG. 6 shows a schematic cross sectional view of a juicer 200, juicer cartridge 100, and beverage container 208. As shown, the juicer has a base, not depicted, that supports the juicer on a supporting surface. The juicer includes a pressing chamber 210 that is sized and shaped, or otherwise configured, to accept a juicer cartridge 100 in an angled, and possibly substantially vertical, orientation at an angle relative to the supporting surface the base is resting on. The juicer also includes two or more pressing surfaces 202 and 204 that at least partially define, or are located within, a pressing chamber 210. At least one of the pressing surfaces 202, 204 is a displaceable pressing surface 204 located within the pressing chamber. These pressing surfaces 202, 204 may again be similarly oriented in either an angled or substantially vertical orientation relative to the supporting surface such that they are also oriented at an angle relative to the base and associated supporting surface.

To facilitate dispensing juice, an outlet 206 may be may be formed by an opening in the pressing chamber, such as the depicted opening located in pressing surface 204, and located to accept an outlet 108 of the juicer cartridge 100. In some embodiments, during use, a deployment feature 202a may be located on any appropriate portion of the pressing chamber 210, or other portion of the juicer. While in the depicted embodiment the deployment feature 202a is a protrusion formed on the displaceable pressing surface 202, other types of deployment features may be used. When the pressing surface 202 is displaced, the protrusion is pressed against the outlet 108 of the juicer cartridge 100, displacing it out of a plane of the juicer cartridge 100 into a deployed configuration. In the deployed configuration, the outlet 108 extends out of the outlet 206 of the pressing chamber. Additionally, the outlet 206 from the pressing chamber 210 may also define a dispensing area 212 adjacent to and located vertically below the outlet 206 relative to the supporting surface the base rests on to accept a beverage container 208.

In one embodiment, a horizontal plane 220 is oriented parallel to the supporting surface 224 the juice is placed on, and may extend through a top portion of the dispensing area 212 through the outlet 206 from the pressing chamber 210, as well as at least a portion of the juicer cartridge 100, the pressing chamber 210, and the pressing surfaces 202 and 204. Additionally, a second horizontal plane 222 parallel to the surface 224 and plane 220, may be located between the supporting surface and plane 220, such that it passes through the beverage container 208 when positioned within the dispensing area 212, as well as the pressing chamber 210, the corresponding pressing surfaces 202, 204, and the juicer cartridge 100 when located therein.

In addition to the above, the juicer cartridge 100, pressing chamber 210, and the one or more pressing surfaces 202, 204 may have a portion of those components located between the horizontal plane 220 and the corresponding supporting surface 224 a base of the juicer is resting on during use. This may also be viewed as these components extending over at least a portion of the vertical length of the dispensing area 212 relative to the base and supporting surface. Either way, this portion of the various components between plane 220 and the supporting surface 224 and/or base may either individually, or in combination, be greater than or equal to 10%, 20%, 30%, 40%, 50%, 60%, 70%, 80%, 90%, or any other appropriate percentage of those components. Correspondingly, the portion of these components located between the horizontal plane 220 and the supporting surface 224 and/or base either individually, or in combination, may be less than or equal to 90%, 80%, 70%, 60%, 50%, 40%, or any other appropriate percentage of those components. Combinations of these ranges are contemplated including for example a portion of each of these components, either individually, or in combination, located between the supporting surface 224 and the horizontal plane 220, and/or extending over at least a portion of the vertical length of the dispensing area 212, may be between 10% and 90% of these components. Of course other percentages both greater and less than those noted above are also contemplated.

The above-noted frangible, or burstable, seals 116 may refer to a seal 116 that opens in a controlled fashion in a predetermined location when a pressure is applied to the juicer cartridge 100 by an associated juicer. For example, a frangible seal 116 may allow for a juicer cartridge 100 to open automatically and allow juice to be dispensed from the juicer cartridge 100 while not requiring any additional action from the user, such as cutting a portion of a juicer cartridge 100 outlet 108 or removing a seal before loading the cartridge 100 into the juicer, or requiring any additional mechanisms in the juicer to open the cartridge 100. Instead, a frangible seal may open as a part of the normal pressing process when the pressure inside a juicer cartridge 100 exceeds a rupture strength of the seal 116.

For example, in some embodiments, the pressure formed within a juicer cartridge 100 during pressing may be transmitted to a frangible seal 116 as a peeling force. For example, an increased pressure within a juicer cartridge 100 during pressing may apply a force at a seal 116 that tends to separate, or peel apart the bonded layers that form the seal 116. Therefore, the strength of a frangible seal 116 may be defined by its peel strength, which is the force required to peel apart the two layers that are bonded together and open the seal 116. Therefore it should be understood that the term frangible, or burstable seal 116, as used herein, may refer to a portion of a juicer cartridge 100 that is constructed and arranged, or otherwise suitably configured, to open when a pressure or other suitable force above a threshold force or pressure is applied to the juicer cartridge 100. It does not necessarily refer to a seal 116 that opens or ruptures violently in an uncontrolled manner at a previously undetermined location.

Further, opening of a frangible seal 116 does not refer to bursting open an integral sheet or layer of material that forms another portion of the juicer cartridge 100, or a structural feature such as a bond around the perimeter of a juicer cartridge 100 that is not intended to open during normal use. For example, the frangible, or burstable, seal 116 may have a rupture strength that is less than a rupture strength of the other seals 116 formed in the juicer cartridge 100 such that the frangible, or burstable, seal 116 opens prior to another seal of the juicer cartridge 100 opening.

Suitable materials to form a frangible seal 116 in a juicer cartridge 100 include, but are not limited to, thermally activated adhesives. Such adhesives form an adhesive bond only in areas that are appropriately treated with heat and pressure after the adhesive is applied. In this manner, thermally activated adhesives may allow for simple control of the seal geometry during manufacturing of juicer cartridges 100. For example, a heated stamp, which may be shaped in accordance with a desired geometry of the frangible seal 116, may press together layers of liquid impermeable material that have been coated with a thermally activated adhesive to form the seal 116. Further, a thermally activated adhesive may be beneficial as it may allow for careful control of the bond strength via control of the temperature of the stamp, or press, used to activate the adhesive. Accordingly, in some embodiments the bonding temperature used to bond a thermally activated adhesive to form a frangible seal 116 may be carefully controlled to provide a consistent seal 116 strength.

In some embodiments, the one or more liquid impermeable and liquid permeable compartments 102, 104 may made from one or more layers of liquid impermeable and liquid permeable materials, respectively. The outer liquid impermeable layer may be made from any appropriate material. For example, the outer liquid impermeable layer may be made from an appropriate polymer (e.g. blended polyester-polyethylene, polypropylene, and others), metal foil, or any other appropriate material. Additionally, in some embodiments, it may be desirable to provide an outer layer made from a biodegradable material including, but not limited to, biodegradable plant-based polymers such as cellulose, cellophane, or polylactic acid.

Appropriate materials for the inner liquid permeable layers include, but are not limited to, a filtration membrane, a nonwoven filtration material, woven mesh, fabric filters, plates with appropriately sized holes or openings, combinations of the above, and other appropriate types of filters. Additionally, these liquid permeable layers may be made from any appropriate material including, for example, metals such as aluminum, polylactic acid, polypropylene fibers, and blended polyester-polyethylene to name a few. In one exemplary embodiment, a liquid permeable layer may be made from a food-grade porous membrane comprising a plurality of pores of a desired size. Other possible embodiments for the one or more liquid permeable layers include aluminum or plastic meshes, cheesecloth, and paper filters. In view of the above, it should be understood that the one or more liquid permeable layers may correspond to any porous material including pores, or other openings, of a suitable size capable of at least partially filtering the juice extracted from food matter contained within a juicer cartridge 100.

The one or more liquid permeable layers may have an appropriate filtration size selected according to the food matter contained in the juicer cartridge 100 such that liquid can pass through the liquid permeable layers while trapping pulp, seeds, pith, peel, and any other undesirable matter.

By way of example, ginger may typically generate large, fibrous pulp matter that can be trapped by larger pores while still permitting the juice extracted from the ginger to pass through the membrane. In contrast, strawberries may be pressed into a pulp matter having small fibers and seeds, which requires a mesh filter with smaller pores to trap the seeds. While in some embodiments, a filtration size may be selected to remove substantially all of the solid material such as pulp from a juice, in some embodiments, a filtration size of the liquid permeable layers may be selected to permit a certain portion of the solid materials (e.g. pulp) to pass through. In instances where a juicer cartridge 100 includes multiple types of food matter 106 in separate pouches requiring different levels of filtration, a juicer cartridge 100 may include multiple liquid impermeable layers with different filtration sizes associated with the different types of food matter. For example, appropriate pore or mesh sizes may range between 2 microns to 500 microns, 100 microns to 400 microns, 200 microns to 300 microns, and other appropriate mesh sizes. Further, embodiments, in which pore or mesh sizes both smaller and larger than those noted above are also contemplated as the disclosure is not so limited.

In one embodiment, a juicer cartridge 100 may include an outer liquid impermeable layer made from a polyethylene/polyethylene terephthalate (PE/PET) blend. The inner liquid permeable material may include a mesh made comprising fibers with a high density polyethylene (HDPE) shell and a PET core. As discussed above, the liquid permeable layer may be bonded together with the outer liquid impermeable layer. Accordingly, in some instances an adhesive material may be provided on an interior surface of the PE/PET liquid impermeable layer to promote compatibility with the HDPE/PET mesh material when they are bonded together with a suitable bonding technique, such as thermal or ultrasonic welding. For example, a suitable adhesive material may include a low density polyethylene sealant layer, though, any appropriate adhesive material may be used. In other embodiments, a juicer cartridge 100 may be compostable, and the PE/PET outer layer and HDPE/PET inner mesh may be replaced with suitable compostable materials. In view of the above, it should be understood that the liquid permeable compartment 104 and/or liquid impermeable compartment 102 may be made from a lamination of materials. For example, a liquid impermeable compartment may be made from a polymer film laminated to an outer paper layer. Of course other constructions and materials are also contemplated.

As discussed above, in some embodiments, the strength of a frangible seal 116 may be defined by its peel strength. In one embodiment, a frangible or burstable seal 116 may have a peel strength between 20 grams/inch and 2000 grams/inch, 100 grams/inch and 2000 grams/inch, 500 grams/inch and 2000 grams/inch, or any other appropriate peel strength. A peel strength in this range may be large enough to reduce the chance of the seal 116 opening unintentionally before pressing, while also being small enough to allow the seal to open before the pressure within the cartridge becomes too high during pressing. A frangible seal 116 may be formed by pressing and heating a thermally activated adhesive, thermally welding, ultrasonically welding, applying pressure sensitive adhesives, or otherwise joining the opposing layers to one another in any other appropriate manner to form the desire frangible or burstable seal 116.

As also noted previously, a juicer cartridge 100 may be constructed and arranged such that it is capable of supporting pressures and forces applied to it during a pressing operation without bursting open, or otherwise failing, in an uncontrolled fashion. For example, pressing on a juicer cartridge 100 may open an associated outlet 108 in a controlled fashion while the remaining portions of the juicer cartridge 100 remained substantially intact. This may be accomplished using any number of different types of constructions and arrangements.

However, in one embodiment, a liquid permeable compartment or pouch and/or a liquid permeable compartment or pouch disposed therein may include seal that extend at least partially, and/or entirely, around their outer peripheries as well as around at least a portion of a seal forming a portion of deployable outlet 108 as previously described. These seals may be designed to withstand the applied juicing pressures in a variety of ways. For instance, a strength of the material a compartment is made of, a thickness of the material layers forming the compartment, and/or a width of the seal may be selected to withstand the applied pressures. Therefore, any appropriate combination of these parameters, or other appropriate design parameters, may be used to provide a seal with a desired strength. Of course, these seals may be formed in any number of ways, and may correspond to any number of different structures. For example, a seal may correspond to an ultrasonic weld, a thermal weld, layers of material bonded together with adhesives, stitches, mechanically interlocking features, or any other appropriate method of forming a compartment or pouch.

Depending on the particular embodiment, a juicer cartridge 100, and the associated seals described above used to form the various compartments and/or pouches, may be constructed to support any appropriate combination of forces and/or pressures that are sufficient to extract juice from the food matter contained therein. For example, in one embodiment, a juicer cartridge 100 may be constructed to support forces that are between or equal to about 6,700 N to 35,600 N (1500 pounds of force to about 8000 pounds of force), 17,800 N to about 44,500 N (4000 pounds to about 10,000 pounds), 8900 N to 53,400 N (2000 pounds to 12,000 pounds), or any other appropriate range of forces as the disclosure is not so limited. Correspondingly, depending on the particular size of an active pressing region of a juicer cartridge 100, the juicer cartridge 100 may correspondingly be constructed to support pressures for extracting juice from the food matter contained therein that are greater than or equal to about 0.14 MPa (20 lb/in2), 0.34 MPa (50 lb/in2), 0.7 MPa (100 lb/in2), 1.4 MPa (200 lb/in2), or any other appropriate pressure. Correspondingly, the juicer cartridge 100 may support pressures for extracting juice from the food matter contained therein that are less than or equal to about 2.4 MPa (350 lb/in2), 2.1 MPa (300 lb/in2), 1.7 MPa (250 lb/in2), 1.4 MPa (200 lb/in2), 0.7 MPa (100 lb/in2), or any other appropriate pressure. Combinations of the above pressure ranges are contemplated including, but not limited to, between or equal to about 0.14 MPa (20 psi) to 2.4 MPa (350 psi), 0.7 MPa (100 psi) to 2.4 MPa (350 psi), 0.7 MPa (100 psi) to 2.1 MPa (300 psi), or any other desirable combinations of pressures. Of course pressure and force ranges both larger and smaller than those noted above are contemplated as the disclosure is not so limited.

While the present teachings have been described in conjunction with various embodiments and examples, it is not intended that the present teachings be limited to such embodiments or examples. On the contrary, the present teachings encompass various alternatives, modifications, and equivalents, as will be appreciated by those of skill in the art. Accordingly, the foregoing description and drawings are by way of example only.

1. An apparatus for extracting juice from food matter, comprising:
a liquid impermeable compartment having an outer perimeter;
a food matter region contained within the outer perimeter; and
a deployable outlet formed in the liquid impermeable compartment outside of the food matter region.

2. The apparatus of claim 1, further comprising a seal joining opposing surfaces of the liquid impermeable compartment within the outer perimeter.

3. The apparatus of claim 2, wherein the seal comprises a weakened area extending along at least a portion of its length to form the deployable outlet.

4. The apparatus of claim 2, wherein the deployable outlet extends from the liquid impermeable compartment through the seal, and wherein the seal extends at least partially along the outer perimeter.

5. The apparatus of claim 4, wherein a first portion of the deployable outlet extends in a first direction through the seal and a second portion of the deployable outlet extends in a second direction through the seal.

6. The apparatus of claim 1, further comprising a liquid permeable compartment at least partially surrounded by the liquid impermeable compartment, wherein an edge of the liquid permeable compartment closest to an upstream portion of the deployable outlet is spaced away therefrom.

7. The apparatus of claim 6, further comprising at least one cutout formed in a portion of the liquid impermeable compartment adjacent to the upstream portion of the deployable outlet, wherein the edge of the liquid impermeable compartment is spaced away from the at least one cutout.

8. The apparatus of claim 6, further comprising a divider extending along at least a portion of the liquid permeable compartment, wherein the divider separates a first portion of food matter from a second portion of food matter.

9. A system for extracting juice from food matter, comprising:
a juicer cartridge to retain food matter comprising juice, the juicer cartridge comprising a deployable outlet;
a pressing chamber to receive the juicer cartridge, the pressing chamber comprising at least one displaceable pressing surface and a pressing chamber outlet; and
a deployment feature to selectively deploy the deployable outlet into the pressing chamber outlet.

10. The system of claim 9, the deployment feature comprising a protrusion on the at least one displaceable pressing surface.

11. The system of claim 10, wherein the protrusion deploys the deployable outlet when the at least one displaceable pressing surface is displaced.

12. The system of claim 9, wherein the deployment feature comprises an extendable surface to selectively extend into the pressing chamber against the deployable outlet to deploy the same.

13. The system of claim 9, further comprising a base to rest on a supporting surface during a juicer operation.

14. The system of claim 13, wherein the pressing chamber is configured to accept the juicer cartridge in an angled orientation relative to the supporting surface.

15. The system of claim 13, wherein the pressing chamber comprises a lower portion located close to the base and an upper portion located away from the base, wherein the upper portion comprises the pressing chamber outlet.

16. The system of claim 13, further comprising a dispensing area adjacent to the pressing chamber outlet.

17. A method for extracting juice from food matter, comprising:
retaining food matter within a food matter region of a juicer cartridge, wherein the food matter region is contained within a liquid impermeable compartment of the juicer cartridge;
actuating a deployable outlet of the liquid impermeable compartment, wherein the deployable outlet is formed outside of the food matter region; and
pressing the juicer cartridge to dispense juice from the food matter through the deployable outlet.

18. The method of claim 17, further comprising situating the juicer cartridge within a pressing chamber.

19. The method of claim 18, wherein the pressing chamber comprises at least one displaceable pressing surface.

20. The method of claim 19, further comprising selectively displacing the at least one displaceable pressing surface to actuate the deployable outlet.
